(19) United States
(12) Patent Application Publication
(10) Pub. No.: US 2015/0178860 A1
(43) Pub. Date: Jun. 25, 2015

(54) PROCESS FOR CONFIGURING CONSUMER SOURCE SELECTIONS IN DEREGULATED MARKETS

(71) Applicant: MIKHAIL IVANOVICH SKACHKO, Missouri City, TX (US)

(72) Inventor: MIKHAIL IVANOVICH SKACHKO, Missouri City, TX (US)

(21) Appl. No.: 14/135,288

(22) Filed: Dec. 19, 2013

(51) Int. Cl. G06Q 50/06; G06Q 20/32; G06Q 20/10; G06Q 50/26; H04L 29/08; G06Q 30/00

(52) U.S. Cl. CPC G06Q 50/06; H04L 67/10; G06Q 30/01; G06Q 20/102; G06Q 50/265; G06Q 20/322

(57) ABSTRACT

Some embodiments include novel methods for obtaining information regarding one or more deregulated utility markets, switching between utility providers in a deregulated utility market, and renewing utility contracts with existing utility providers in a deregulated utility market. In some embodiments, the deregulated utility market is one of an electricity market, a natural gas market, and a telecommunications service market. In some embodiments, the methods are implemented in one or more software applications that operate on a computing device (e.g., a mobile device such as a smartphone) that can connect to a network associated with the deregulated utility market.

### BACKGROUND

Embodiments of the invention described in this specification relate generally to deregulated markets, and more particularly, to consumer selections in deregulated markets.

Consumer commodities such as electricity and communication services have traditionally been regulated, leaving consumers with little options for selecting a provider or configuring a level of service to be received. However, many markets have been deregulated. For instance, phone and Internet service is often available to consumers from several different telecommunication providers. Likewise, electricity markets have opened up, allowing a consumer to select, for example, a natural gas provider for some of the consumer's residential energy needs.

Up to this point, however, consumers in deregulated markets have had difficulty understanding how deregulated markets work and what options that have in switching between providers. This has resulted in rather low market-based activity by consumers. As a result, providers have benefited in many deregulated markets at the expense of consumers, who have been limited in or effectively prevented from making free economic choices. This is a problem for consumers, and to the extent this results in market dysfunction, may also be problematic for providers. In particular, this has been issue in electricity, natural gas, and telecommunications markets.

Therefore, what is needed is a way for consumers in deregulated markets to switch between providers, specifically, electricity, natural gas, and telecommunication providers.

### BRIEF DESCRIPTION

Some embodiments of the invention include novel methods for obtaining information regarding one or more deregulated utility markets, switching between utility providers in a deregulated utility market, and renewing utility contracts with existing utility providers in a deregulated utility market. In some embodiments, the deregulated utility market is one of an electricity market, a natural gas market, and a telecommunications service market. In some embodiments, the methods are implemented in one or more software applications that operate on a computing device (e.g., a mobile device such as a smartphone) that can connect to a network associated with the deregulated utility market.

In some embodiments, a consumer can initialize access to a deregulated utility market that services the geographical region. Once initialized, the consumer can obtain educational resources pertaining to deregulation of one or more utility markets.

In some embodiments, the consumer can switch between different utility providers in the deregulated utility market by a method that validates a consumer's authority to switch providers, receives a selection of a provider to which the consumer would like to switch utility server, and notifies the selected provider of the consumer's request to switch. In some embodiments, the method further includes options for renewing a contract with a provider and paying utility bills. To make an informed selection between utility providers and to understand the implications of switching between utility providers in a deregulated market, the consumer can use information obtained by accessing the educational resources related to deregulation of the utility market. In other cases, the consumer can switch utility providers without ever obtaining educational information related to the deregulated market.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process in some embodiments for obtaining deregulation market information for a particular geographical region associated with a consumer.

FIG. 2 illustrates a schematic of electricity educational resources available in some embodiments to a consumer in a deregulated electricity market.

FIG. 3 illustrates a schematic of natural gas educational resources available in some embodiments to a consumer in a deregulated natural gas market.

FIG. 4 illustrates a schematic of telecommunications educational resources available in some embodiments to a consumer in a deregulated telecommunications market.

FIG. 5 conceptually illustrates a process in some embodiments for validating a consumer's authority to make electricity provider changes.

FIG. 6 conceptually illustrates a process in some embodiments for switching electricity providers.

FIG. 7 conceptually illustrates a process in some embodiments for validating a consumer's authority to make natural gas provider changes.

FIG. 8 conceptually illustrates a process in some embodiments for switching natural gas providers.

FIG. 9 conceptually illustrates a process in some embodiments for validating a consumer's authority to make telecommunications provider changes.

FIG. 10 conceptually illustrates a process in some embodiments for switching telecommunications providers.

FIG. 11 conceptually illustrates a process in some embodiments for optionally renewing a utility contract with a utility provider.

FIG. 12 conceptually illustrates an electronic system with which some embodiments of the invention are implemented.

FIG. 13 conceptually illustrates a system architecture in some embodiments.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel process for allowing a consumer to switch between providers in a deregulated market. In some embodiments, the process includes (i) validating a consumer's authority to change providers in a deregulated market, (ii) receiving a selection of a provider in the deregulated market to which the consumer would like to change, and (iii) notifying the selected provider of consumer's request to switch. In some embodiments, the process further includes providing educational resources to the consumer about their provider switching options in the deregulated market. In some embodiments, the process further comprises providing a contract renewal option for a consumer to renew a contract with a provider. In some embodiments, the deregulated market is one of an electricity market, a natural gas market, and a telecommunications service market.

In some embodiments, the process is implemented as a software application that runs on a computing device to allow the consumer to switch between providers in the deregulated market. In some embodiments, the software application is a mobile app that runs on a mobile computing device. In some embodiments, the mobile computing device is communicatively connected over a data network to one or more provider computing devices.

I. Comparing and Selecting Providers Via Mobile Phone

In some embodiments, a consumer using a mobile computing device performs the process. As a preliminary step, the consumer may initialize geographical region information to obtain market information associated with the region. By way of example, FIG. 1 illustrates a process in some embodiments for obtaining deregulation market information for a particular geographical region associated with a consumer. As shown, the consumer enters a zip code to identify the geographical region. In some embodiments, other identification data can be entered to identify the geographical region of the consumer. Once the region is identified, the consumer is presented with an option to view the region's deregulation information for one or more of the electricity market, the natural gas market, and the telecommunications market.

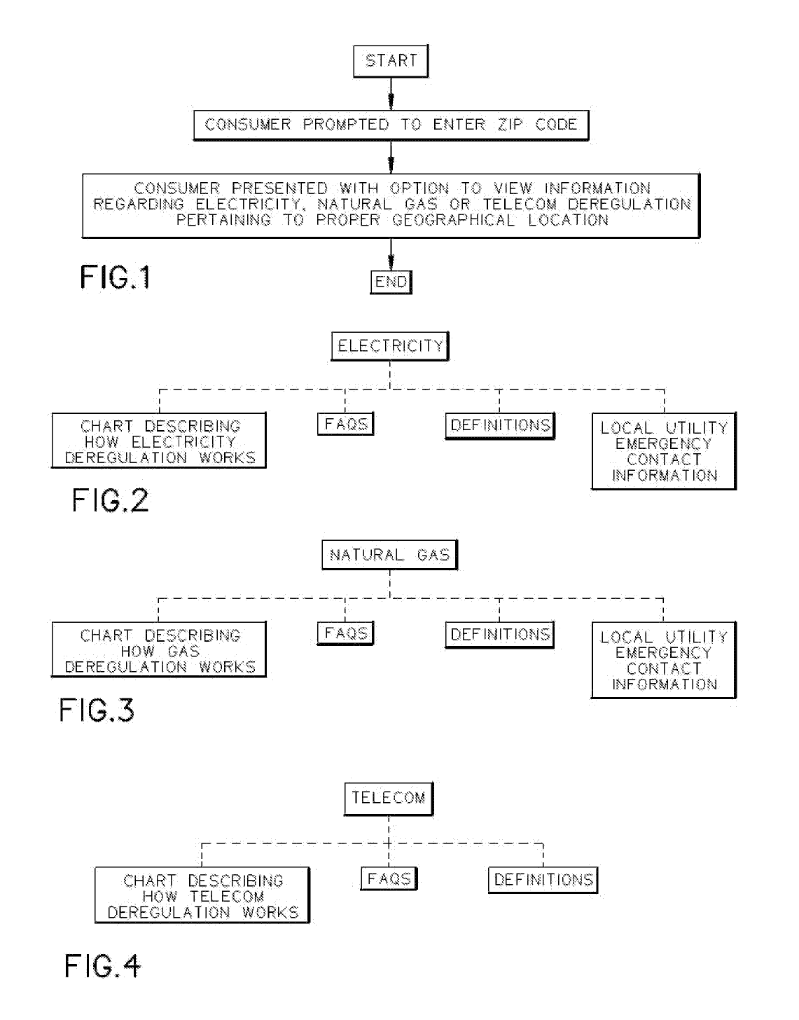

For electricity, the consumer would be presented with information pertaining to deregulation of the electricity market within the identified geographical region. As an example, FIG. 2 illustrates a schematic of electricity educational resources available in some embodiments to a consumer in a deregulated electricity market. As shown, the consumer is presented electricity information in the form of charts describing how electricity deregulation works, a list of frequently asked questions (FAQs), a glossary of definitions, and local utility emergency contact information.

For natural gas, the consumer would be presented with information pertaining to deregulation of the natural gas market within the identified geographical region. As an example, FIG. 3 illustrates a schematic of natural gas educational resources available in some embodiments to a consumer in a deregulated natural gas market. As shown, the consumer is presented natural gas information in the form of charts describing how gas deregulation works, FAQs, definitions, and local utility emergency contact information.

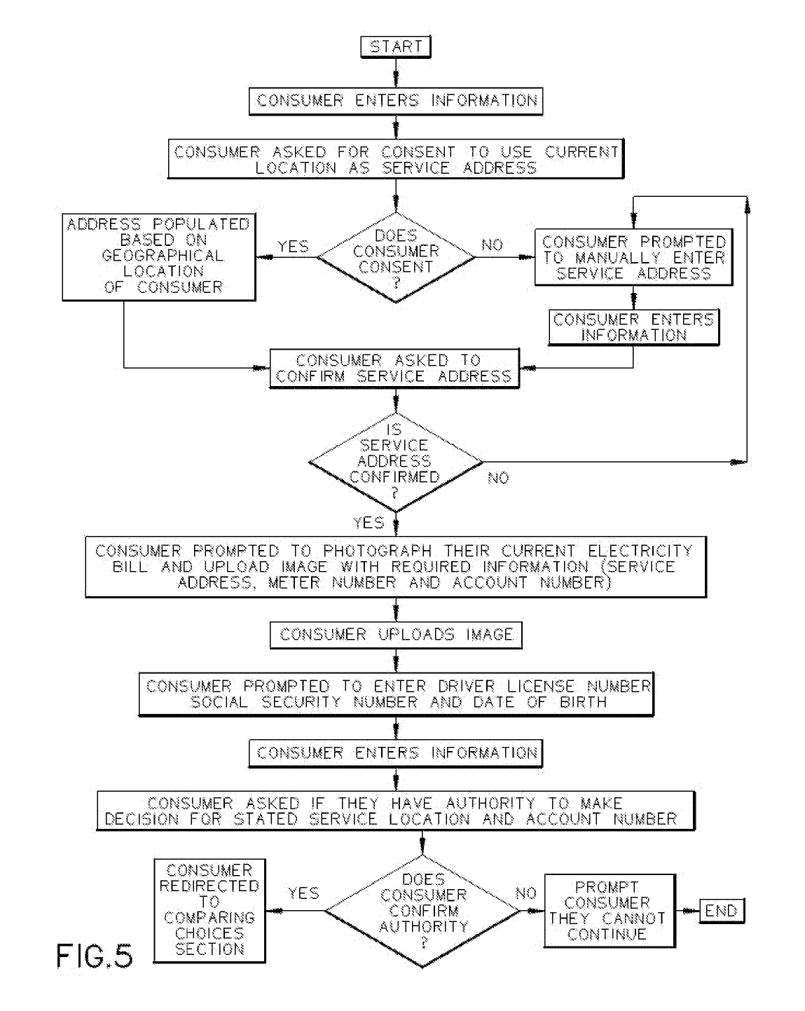

For telecommunications, the consumer would be presented with information pertaining to deregulation of the telecommunications market within the identified geographical region. As an example, FIG. 4 illustrates a schematic of telecommunications educational resources available in some embodiments to a consumer in a deregulated telecommunications market. As shown, the consumer is presented telecommunications information in the form of charts describing how telecommunications deregulation works, FAQs, and definitions. As the educational resources shown in each of FIGS. 2-4 are merely exemplary, in some embodiments other resources or information could be presented to the consumer.

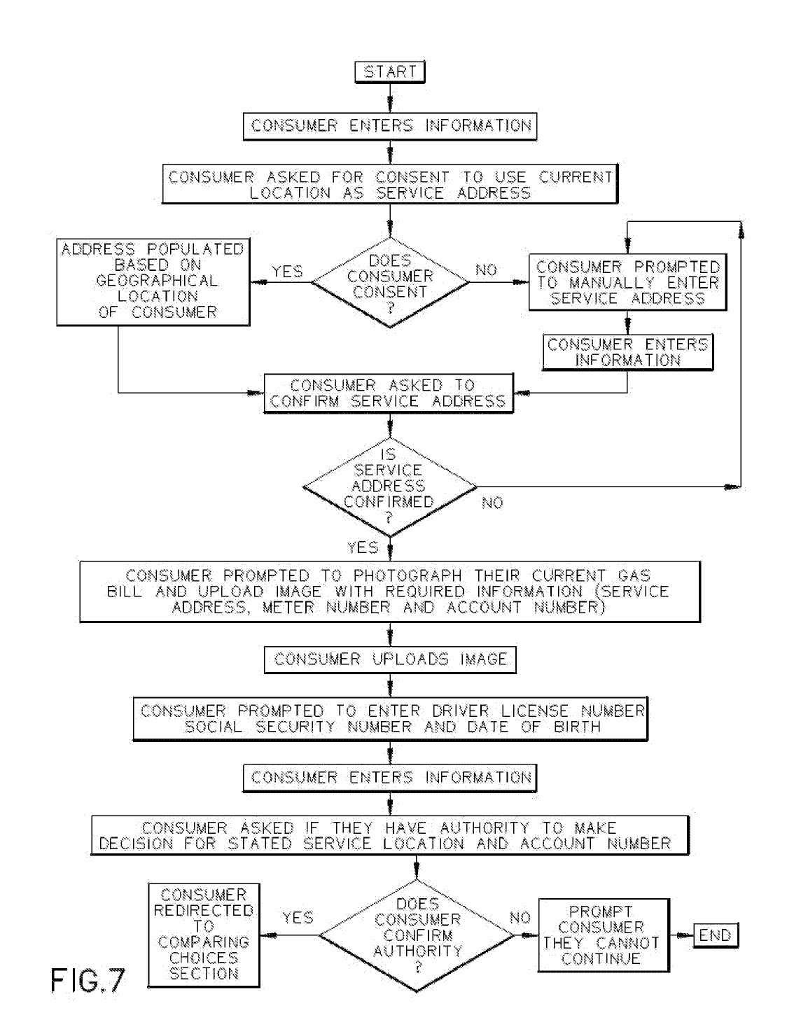

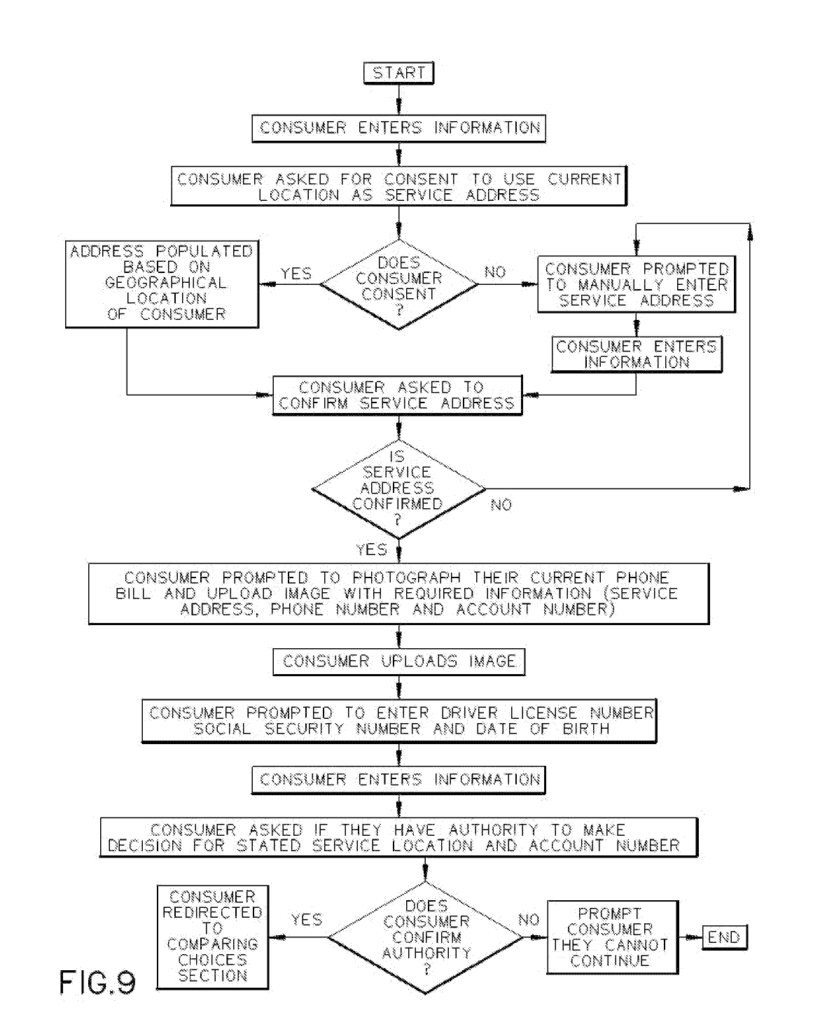

Once the consumer learns about the deregulation information for the market, or in some cases, without accessing the educational resources described by reference to FIGS. 2-4, the consumer may start the process for switching utility providers. In some embodiments, before a consumer is permitted to make a switch from one provider to another provider in a deregulated market, the consumer's identity is confirmed for validation of the consumer's authority to make changes to the provider. By way of example, each of FIGS. 5, 7, and 9 conceptually illustrates a process for validating a consumer's authority to make utility provider changes. Specifically, FIG. 5 demonstrates steps of the process used to validate the consumer's authority to make changes to the electricity provider, FIG. 7 demonstrates the steps used to validate the consumer's authority to make changes to the natural gas provider, and FIG. 9 demonstrates the steps used to validate the consumer's authority to make changes to the telecommunications provider. In each respective process, the consumer enters some biographical information (e.g., name, entity, etc.) and is then prompted for the service address to use in comparing utility providers.

In some embodiments, the process determines whether the consumer specified to automatically use the current location as the service address. When the process determines that the consumer does not permit the use of the current location, the process prompts the consumer to enter the service address manually, which is described in further detail below. On the other hand, when the process determines that the consumer allows use of the current location, the process then identifies the current location. In some embodiments, the process uses previously entered location information as the current location. In other embodiments, the process uses GPS or other information to determine the current location.

Whatever the manner of retrieving the current location, the process then prompts the consumer to confirm that accuracy of the service address. When the consumer responds by confirming the accuracy, the process begins steps to validate the consumer's identity and authority. However, when the consumer does not confirm the service address, the process transitions back to prompting the consumer to manually enter the service address, as described above. When the consumer enters the location information manually, in some embodiments the process ignores any information related to the current location which it may have available from previous operations. For example, the consumer may be using a computing device at a work location to switch natural gas providers for residential service of his home. In this example, the consumer would manually enter his home address at the service address to use in comparing providers of natural gas. After the consumer has entered the service address manually, the process prompts the consumer to confirm the accuracy of the service address, which was described above.

Next, the process begins steps to validate the consumer's identity and authority to switch utility providers. The process of some embodiments prompts the consumer to provide an image of a current utility bill associated with the current provider. For example, the consumer may be prompted to provide a scanned image of a current electricity bill for the service address. The electricity bill may include sufficient identifying information for the process to validate the consumer's current utility provider. For example, the process may be able to determine the specific electricity company from which the consumer receives electricity service.

After confirming the identity of the consumer's current utility provider for the utility service the consumer intends to change, the process next prompts the consumer to provide one or more of a driver's license number, a social security card number, and the consumer's date of birth. In some embodiments, if the consumer uses a mobile computing device validate authority, the process encrypts all of the information before transmitting to any other computing device for validation. For example, the process may receive input specifying the consumer's social security card number, and encrypt the number to maintain data integrity and privacy for the consumer. In some embodiments, the encryption is performed at each of a visual level (e.g., displaying an asterisks mark for each digit entered for the consumer's social security card number) and a data structure and transmission level (e.g., generating a hash code for the social security card number).

After receiving the consumer's input to validate identity (e.g., driver's license, social security number, date of birth, etc.), the process then prompts the consumer to assert his or her own authority to make a switch of the utility provider for the specified service address. When the consumer's authority to switch utility providers cannot be confirmed, the respective process informs the consumer that they cannot continue to the next stage of switching providers, after which the process ends. On the other hand, when the consumer's authority is confirmed, the consumer will be redirected to the next stage of comparing utility provider choices available in one or more deregulated markets servicing the identified geographical region of the consumer.

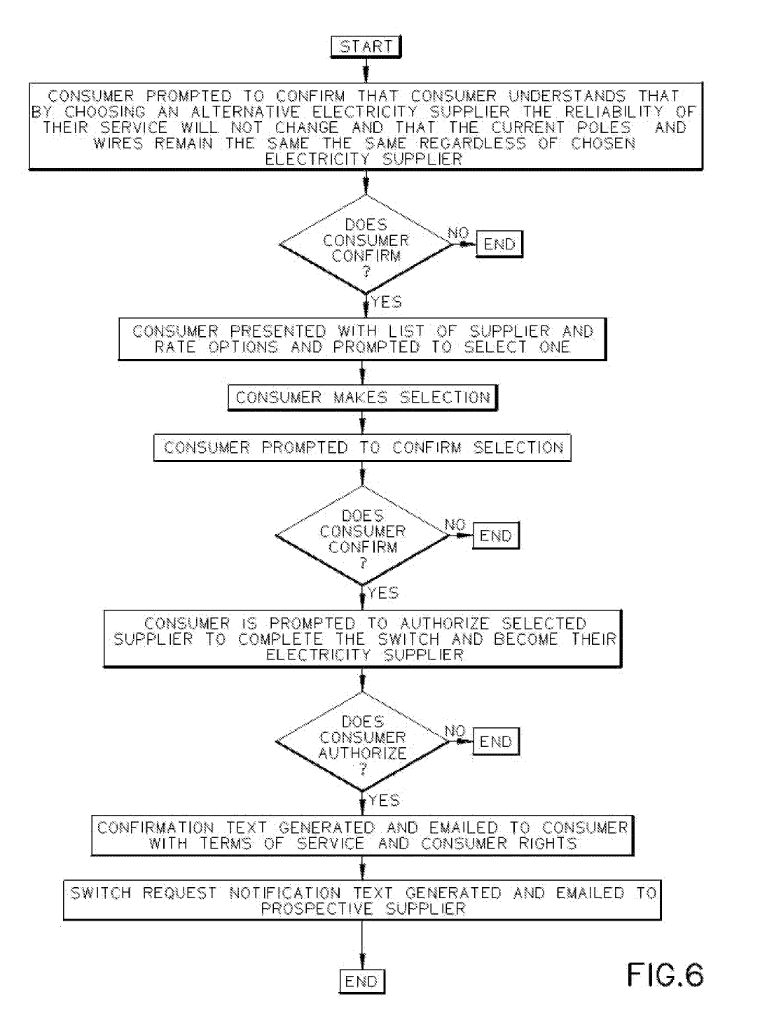

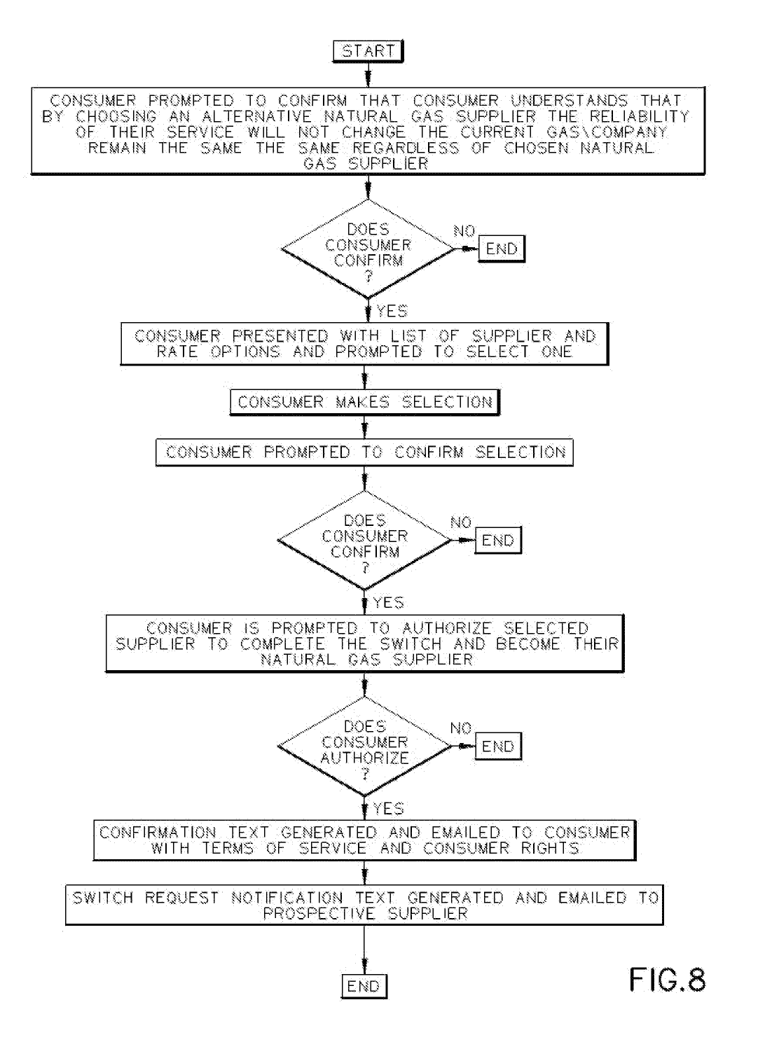

The next stage processes for switching providers of electricity and natural gas are described by reference to FIGS. 6 and 8. As shown in these figures, each process begins by asking whether the consumer understands some of the pertinent details about changing providers. When the consumer responds in the negative, the process ends. Alternatively, when the consumer responds in the affirmative, the process then displays a list of utility providers and associated rate information from which the consumer can select a provider to which the consumer will switch. Each process then receives the consumer's selection and prompts the consumer to confirm the selection. When the consumer does not confirm the selection, the process ends. Alternatively, when the consumer affirmatively confirms the selection, each process prompts the consumer to authorize the selection of the new provider. As above, when the consumer does not confirm the authorization, the process ends. However, when the consumer positively confirms authorization, the process generates and transmits a confirmation of the terms of service associated with service from the newly selected utility provider. Contemporaneously with generating and transmitting the terms of service to the consumer, the process in some embodiments transmits a switch request notification to the utility provider. Then the process ends.

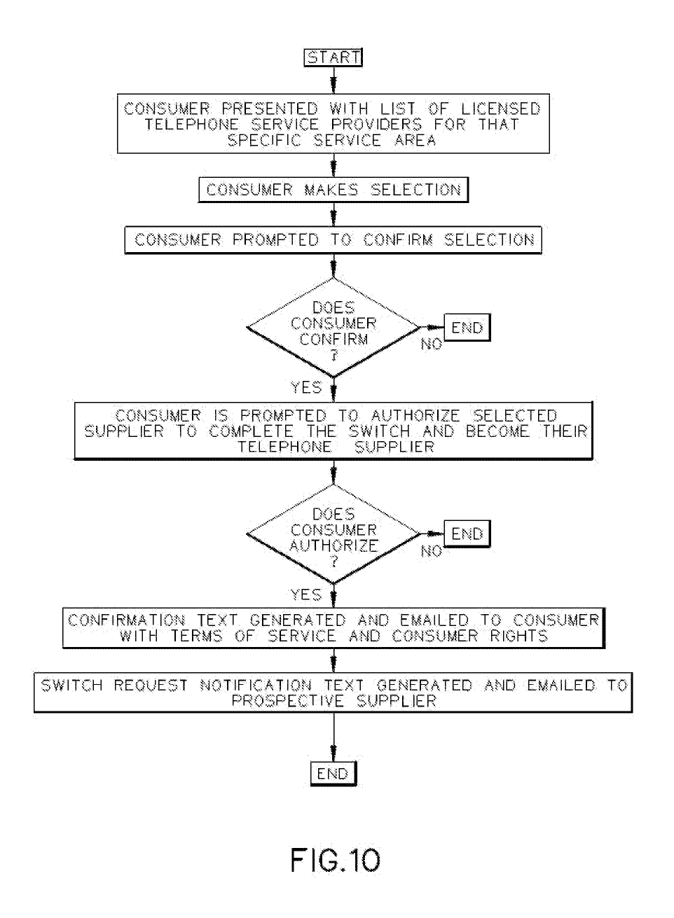

In some embodiments, when the consumer intends to switch telecommunications providers, the process performs the switch to a new telecommunications provider after performing less steps than the processes for switching providers as described above by reference to FIGS. 6 and 8. The reduced steps is a matter of service provided in some cases. By way of example, FIG. 10 conceptually illustrates an example of such a process for switching telecommunications providers. As shown in this figure, the process starts by presenting a list of the available provides based on the geographical region identified by reference to the automatically detected or manually entered service location. Next, the process receives a selection of a particular telecommunications provider from the list and then prompts the consumer to confirm the selected provider. The process ends when the consumer responds in the negative to the confirmation request. On the other hand, the process proceeds to the authorization stage when the consumer responds affirmatively to the confirmation request.

When the process receives confirmation of the provider selection, the process then requests authorization from the consumer. In some embodiments, the utility provider switch will not be complete until the consumer authorizes switching to the selected and confirmed utility provider. When no authorization is provided, the process of some embodiments ends. However, when the consumer authorizes the switch, the process generates a confirmation text message (e.g., email, SMS message, etc.) and sends the message to the consumer. In some embodiments, the confirmation message includes a set of terms and conditions for the telecommunications service offered by the provider selected by the consumer. In some cases, a set of consumer rights are included in the confirmation message. After sending the consumer a confirmation message regarding the switch of telecommunications providers, the process sends a request to the selected provider requesting establishment of telecommunications service for the consumer. In some embodiments, the message sent to the telecommunications service provider is sent contemporaneously with the message sent to the consumer confirming the switched service provider selection. In other embodiments, the consumer must affirmatively accept the terms and conditions of service after receiving the confirmatory message, and only then will the process transmit a request to the new telecommunications service provider to establish telecommunications service for the consumer. Then the process ends.

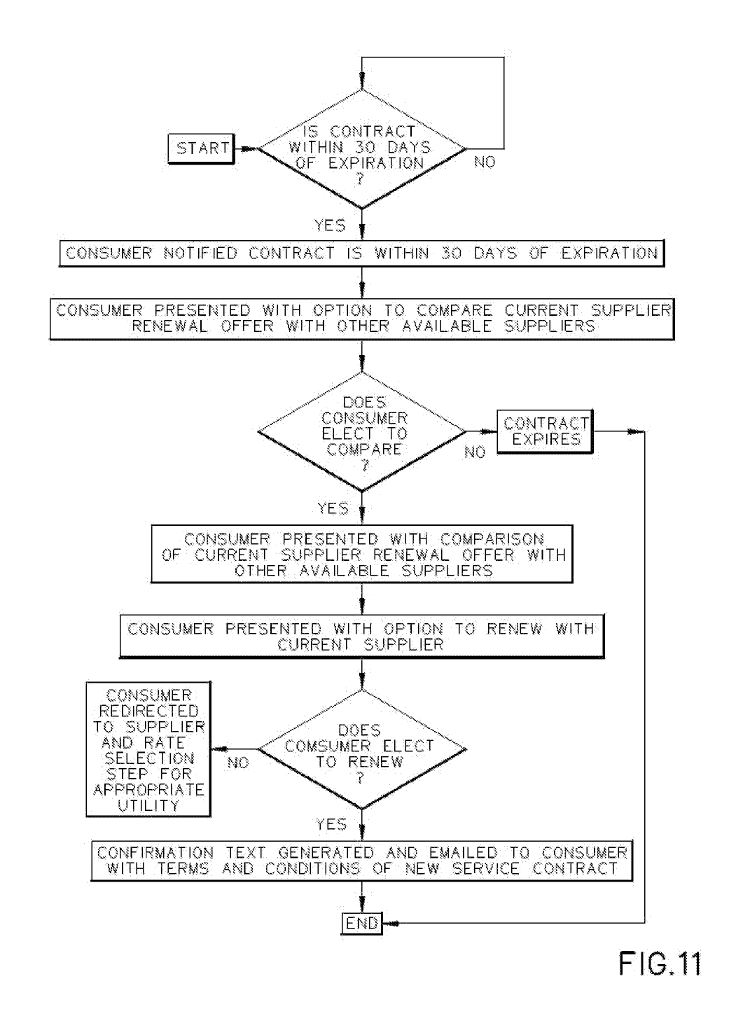

In some embodiments, a consumer does not necessarily intend to switch utility providers. Instead, some consumers simply wish to review contract renewal options from an existing provider of a utility whose service contract with the consumer is set to expire within a short amount of time. FIG. 11 conceptually illustrates such a process which in some embodiments allows a consumer to optionally renew an existing utility contract with an existing utility provider. In some embodiments, the process starts when a contract between a consumer and a utility provider is set to expire within a short amount of time. In some embodiments, the amount of time is a threshold amount of time such that the consumer will not be presented an option to renew a contract if the contract is not set to expire within the threshold amount of time. For example, the process may give the consumer an option to compare prices from the provider if the consumer has a current contract with the provider that is set to expire within 30 days. In some embodiments, if the time to expire satisfies the threshold, the consumer is notified of the pending expiration. The process then presents one or more options for the consumer to compare providers. In some embodiments, the consumer is sent a text message (e.g., email message, SMS, etc.) with the remaining time on the contract and options for comparing providers. In some embodiments, the consumer receives notification of the remaining contract time and a list of provider comparison options upon logging into an account with the utility provider via a mobile communication or computing device with an application for renewing utility contracts in deregulated markets.

When the consumer elects not to compare provider offerings, in some embodiments, the process ends. On the other hand, when the consumer affirmatively elects to compare provider options, the process presents a comparison of current provider renewal offerings along with one or more other providers' offerings. In some embodiments, the process filters a list of other providers such that only a select set of providers, each having at least one contract item at terms more favorable to the consumer than a corresponding contract item in a renewal contract offered by the existing utility provider. For example, the existing provider of natural gas for a consumer may offer a gas rate than is more expensive than a prior contract rate from the same provider, and which is more expensive to the consumer than the gas rate offered by two competing gas providers in the service area of the consumer.

Based on the information presented, the consumer in some embodiments is able to renew the contract with the existing provider. In contrast, the consumer may elect not renew the contract with the existing provider. In these embodiments, the process redirects the consumer to the utility provider selection and confirmation processes described by reference to FIGS. 5 and 6, FIGS. 7 and 8, or FIGS. 9 and 10. On the other hand, when the consumer affirmatively elects to renew the contract with the existing utility provider, the process then generates a confirmation text to send to the consumer (e.g., email, SMS message, etc.). The confirmation text in some embodiments includes the terms and conditions of the renewed contract and any new conditions of the contract (i.e., terms not included in the prior contract). Then the process ends.

As mentioned above, in some embodiments the process is implemented as an program (i.e., a software application or “app”) that runs on a portable-multifunction device (i.e., a “mobile computing device”), such as a smartphone-type mobile communication device or a mobile tablet computing device. The mobile computing device includes a processor or processing unit for processing sets of instructions of the app. Such mobile computing devices also commonly include onboard communication devices such as GPS devices, WiFi devices, cellular receivers/transmitters, etc. In some embodiments, a consumer with a mobile computing device can access a service of the deregulated utility. For instance, the example processes described above may be implemented as apps which are specifically designed for and access a mobile network associated with the deregulated electricity, natural gas, and phone providers. In addition, these processes can be adapted to operate for consumers switching service providers for any of several other areas and interests.

The various steps of the processes of the present disclosure as presented in the figures and in this specification may be presented to the consumer on any of these mobile computing devices as a set of graphical user interfaces (GUIs) that are displayed on a display screen of the mobile computing device in the following exemplary fashion. It is not intended to limit the scope or nature of the relationships between the various steps and the following example GUIs are presented as illustrative examples only.

A first GUI display (or main screen) of the app may ask for the consumer to enter their zip code, and based on the received zip code input, the app may then route the consumer to the appropriate geographical area or region. In some cases, the GUI may display a map or a map with satellite (i.e., life-like aerial) imagery of the geographical region. In other cases, a different GUI display is rendered on the display screen without a map, but with a set of information referring to the identified geographical region. Once on the page that is relevant to the consumer based on the zip code, the consumer will have options for proceeding through one or more of the processes described above. In some embodiments, these options are selectable menu options which when selected present a corresponding GUI display that features information, tools, and other graphical items relating to the selected option. In other embodiments, the options are presented in another format which allows the consumer to make selections among the options. For instance, a tile-based rendering of the different options may be displayed as a GUI selection screen in some apps. Regardless of the manner in which a consumer can make selections, each of the options are displayed with a corresponding GUI. Each of the corresponding GUIs includes one or more sub-options that feature associated information, tools, or functions for the consumer to use the app in the associated deregulated utility. The corresponding GUIs are not limited to, but may include:

1. A GUI for obtaining education on deregulation for the utility providers associated with the identified geographical region.

2. A GUI for comparing electricity choices and rates for selection.

3. A GUI for comparing natural gas choices and rates for selection.

4. A GUI for comparing telecommunications choices and rates for selection.

5. A GUI for renewing an existing contract that is near expiration.

6. A GUI for paying utility bills.

In this way, consumers can easily navigate through a set of options which enable them to compare utility provider choices and rates, and thereby, make informed selections of the utilities in the deregulated market. While the GUIs described above may be included in a single app, a person of skill in the art would understand that subsets of the GUIs can be implemented in one app and other subsets of the GUIs can be implemented in other apps. For instance, a first app for a deregulated electricity market may feature a GUI for obtaining education on deregulation, a GUI for comparing and selecting electricity providers, and a GUI for setting options, such as automatic bill-pay to the selected electricity provider, while a second app for a deregulated telecommunications market may feature a GUI for obtaining educational resources and a GUI for comparing and selecting telecommunications providers. A person of skill in the art would understand that the GUI display screens described above are only exemplary and not intended to limit this disclosure, as any app could have several other related GUI display screens which assist consumers with respect to one or more options in a deregulated markets.

II. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

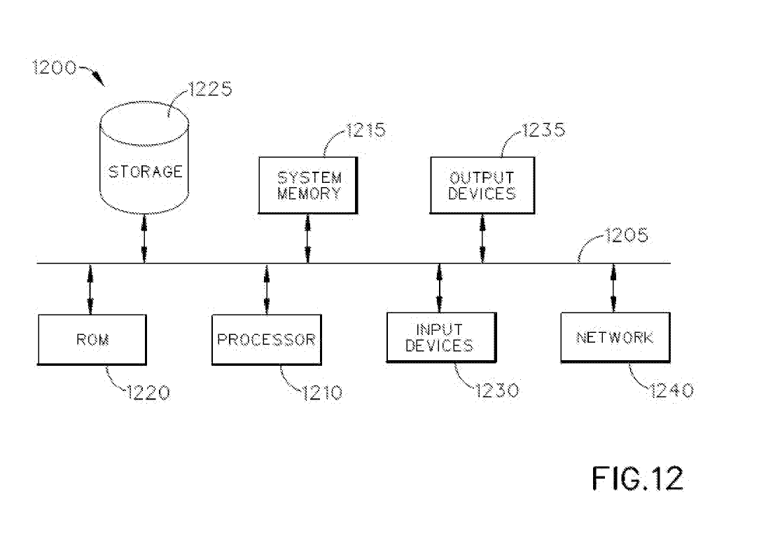

FIG. 12 conceptually conceptually illustrates an electronic system 1200 with which some embodiments of the invention are implemented. The electronic system 1200 may be a computer, phone, PDA, or any other sort of electronic device. Such an electronic system includes various types of computer readable media and interfaces for various other types of computer readable media. Electronic system 1200 includes a bus 1205, processing unit(s) 1210, a system memory 1215, a read-only 1220, a permanent storage device 1225, input devices 1230, output devices 1235, and a network 1240.

The bus 1205 collectively represents all system, peripheral, and chipset buses that communicatively connect the numerous internal devices of the electronic system 1200. For instance, the bus 1205 communicatively connects the processing unit(s) 1210 with the read-only 1220, the system memory 1215, and the permanent storage device 1225.

From these various memory units, the processing unit(s) 1210 retrieves instructions to execute and data to process in order to execute the processes of the invention. The processing unit(s) may be a single processor or a multi-core processor in different embodiments.

The read-only-memory (ROM) 1220 stores static data and instructions that are needed by the processing unit(s) 1210 and other modules of the electronic system. The permanent storage device 1225, on the other hand, is a read-and-write memory device. This device is a non-volatile memory unit that stores instructions and data even when the electronic system 1200 is off. Some embodiments of the invention use a mass-storage device (such as a magnetic or optical disk and its corresponding disk drive) as the permanent storage device 1225.

Other embodiments use a removable storage device (such as a floppy disk or a flash drive) as the permanent storage device 1225. Like the permanent storage device 1225, the system memory 1215 is a read-and-write memory device. However, unlike storage device 1225, the system memory 1215 is a volatile read-and-write memory, such as a random access memory. The system memory 1215 stores some of the instructions and data that the processor needs at runtime. In some embodiments, the invention's processes are stored in the system memory 1215, the permanent storage device 1225, and/or the read-only 1220. For example, the various memory units include instructions for processing appearance alterations of displayable characters in accordance with some embodiments. From these various memory units, the processing unit(s) 1210 retrieves instructions to execute and data to process in order to execute the processes of some embodiments.

The bus 1205 also connects to the input and output devices 1230 and 1235. The input devices enable the user to communicate information and select commands to the electronic system. The input devices 1230 include alphanumeric keyboards and pointing devices (also called “cursor control devices”). The output devices 1235 display images generated by the electronic system 1200. The output devices 1235 include printers and display devices, such as cathode ray tubes (CRT) or liquid crystal displays (LCD). Some embodiments include devices such as a touchscreen that functions as both input and output devices.

Finally, as shown in FIG. 12, bus 1205 also couples electronic system 1200 to a network 1240 through a network adapter (not shown). In this manner, the computer can be a part of a network of computers (such as a local area network (“LAN”), a wide area network (“WAN”), or an Intranet), or a network of networks (such as the Internet). Any or all components of electronic system 1200 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, processes are conceptually illustrated in FIGS. 1 and 5-11. The specific operations of each process may not be performed in the exact order shown and described. Specific operations may not be performed in one continuous series of operations, and different specific operations may be performed in different embodiments. Furthermore, the processes could be implemented using several sub-processes, or as part of larger macro processes. Also, FIGS. 2-4 conceptually illustrate examples of consumer options that may be presented to a consumer as a set of GUIs in a software application that implements one or more of the processes described by reference to FIGS. 1 and 5-11. The specific layout and design of the GUI may not be organized in exactly the same manner and may include different options than those shown in the examples. Thus, one of ordinary skill in the art would understand that the invention is not to be limited by the foregoing illustrative details and examples, but rather is to be defined by the appended claims.

III. Utility Service System

Many of the above described features are available to consumers by way of a utility service that allows consumers to compare and select utility providers in deregulated utility markets. In particular, a deregulated market utility service, in some embodiments, analyzes consumer selections to provide options and features for display on a mobile computing device to enable the consumer to obtain deregulation information pertaining to the market and make informed selections of utility providers offering services within the deregulated market. A utility service may obtain utility service data from internal or external sources. For example, consumer selections may be obtained from the mobile computing device that the consumer uses to compare and select a utility provider, the consumer's current utility provider information may be obtained from an internal information source (e.g., a utility provider database), and the consumer's geographical region may be obtained from external services (e.g., GPS assistance servers, wireless network coverage databases, etc.) that identify location.

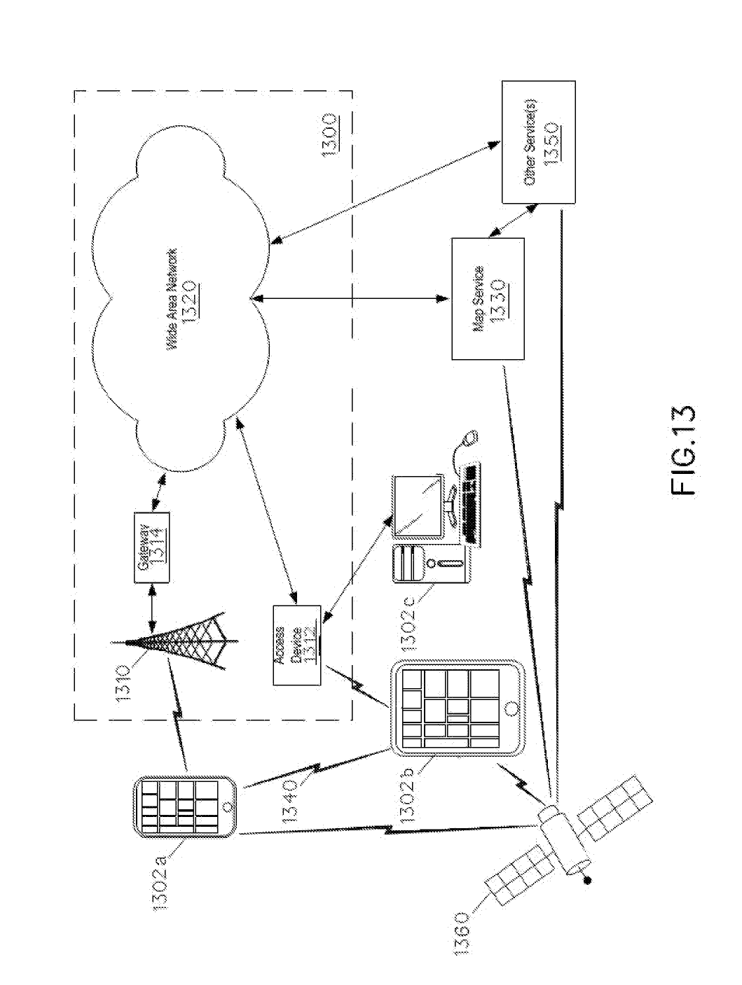

FIG. 13 illustrates one possible embodiment of an operating environment 1300 for a utility service 1330 in a deregulated market that provides service options to consumer computing devices 1302a-1302c. Various embodiments of computing devices (e.g., consumer computing devices 1302a-1302c) are implemented on different portable-multifunction device types. Devices 1302a and 1302b can be any portable electronic or computing device capable of communicating with a utility service. Device 1302c can be any non-portable electronic or computing device capable of communicating with a utility service. In some embodiments, consumer computing devices 1302a-1302c obtain utility service data (e.g., deregulation education resources, utility provider directories, rate information, etc.) from utility service 1330.

Consumer computing devices 1302a-1302c access utility service 1330 through various communication methods and protocols. In some embodiments, the computing devices 1302a-1302c communicate over one or more wired or wireless networks 1310 and/or 1312. For example, wireless network 1310, such as a cellular network, can communicate with a wide area network (WAN) 1320, such as the Internet, by use of a gateway 1314. The gateway 1314 in some embodiments provides a packet oriented mobile data service, such as General Packet Radio Service (GPRS), or other mobile data service allowing wireless networks to transmit data to other networks, such as wide area network 1320 (i.e., the Internet). Likewise, access device 1312 (e.g., IEEE 802.11g wireless access device) provides communication access to WAN 1320.

In various embodiments, any of the illustrated consumer mobile devices 1302a-1302c may communicate with utility service 1330 and/or other service(s) 1350 using a persistent connection established in accordance with one or more security protocols, such as the Secure Sockets Layer (SSL) protocol or the Transport Layer Security (TLS) protocol. Devices 1302a and 1302b can also establish communications by other means. For example, wireless device 1302a can communicate with other wireless devices (e.g., other devices 1302b, cell phones, etc.) over the wireless network 1310. Likewise devices 1302a and 1302b can establish peer-to-peer communications 1340 (e.g., a personal area network) by use of one or more communication subsystems, such as Bluetooth® communication from Bluetooth Special Interest Group, Inc. of Kirkland, Wash. Although not shown in this figure, device 1302c can also establish peer-to-peer communications with devices 1302a or 1302b. Other communication protocols and topologies can also be implemented. Devices 1302a and 1302b may also receive Global Positioning Satellite (GPS) signals from GPS satellites 1360.

In some embodiments, when any of the devices 1302a, 1302b, and 1302c communicate with utility service 1330 over wired or wireless networks, 1310 and/or 1312, the utility service 1330 can provide data on different utility providers for comparison and selection. Utility service 1330 may also communicate with other services 1350 to obtain data to implement changes in a consumer's utility provider. For instance, other services 1350 may include services and/or data provided by a particular utility provider. Utility service 1330 and other services 1350 may also receive GPS signals from GPS satellites 1360.

In various embodiments, utility service 1330 and/or other service(s) 1350 provide one or more utility provider update mechanisms to update a utility provider regarding a consumer's selection of receiving service from a different utility provider. For instance, utility service 1330 may provide updated consumer utility provider selections to other service(s) 1350 (e.g., an update to a former utility provider that a consumer will end service with the utility provider on a specified date, etc.). The information provided by the update mechanism may be used by the former utility provider to propose an offer to the consumer for service in light of the terms provided by the utility provider that consumer selected.

While the invention has been described with reference to numerous specific details, one of ordinary skill in the art will recognize that the invention can be embodied in other specific forms without departing from the spirit of the invention. For instance, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a mobile computing device enables a consumer to select a utility provider in a deregulated utility market, said program comprising sets of instructions for:
receiving a set of consumer registration data comprising a service address to use for utility service;
receiving an image of consumer's utility bill;
receiving a set of confidential consumer information used to validate the identity of the consumer;
receiving a confirmation of consumer's authority to change utility providers;
displaying a set of utility providers that provide utility service to the received service address;
receiving a selection of a utility provider to provide utility service to the service address for the consumer, wherein said selection switches the utility provider of the service address; and
sending a request to switch providers to the selected utility provider.

2. The non-transitory computer readable medium of claim 1, wherein the utility is electricity and the set of utility providers are electricity service providers.

3. The non-transitory computer readable medium of claim 1, wherein the utility is natural gas and the set of utility providers are natural gas service providers.

4. The non-transitory computer readable medium of claim 1, wherein the utility is telecommunications and the set of utility providers are telecommunications service providers.

5. The non-transitory computer readable medium of claim 1, wherein the program further comprises a set of instructions for requesting consent to automatically identify the service address of the consumer.

6. The non-transitory computer readable medium of claim 5, wherein the program further comprises sets of instructions for:
receiving the consumer's consent; and
automatically identifying the service address of the consumer.

7. The non-transitory computer readable medium of claim 6, wherein the set of instructions for automatically identifying the service address of the consumer comprises sets of instructions for:
identifying a geographical region of the service address; and
compiling a list of utility providers who provide utility service within the geographical region.

8. The non-transitory computer readable medium of claim 1, wherein the image of the consumer's utility bill comprises at least one of a meter number and an account number.

9. The non-transitory computer readable medium of claim 1, wherein the set of confidential consumer information comprises one or more of a driver's license number, a social security number, and a date of birth for the consumer.

10. The non-transitory computer readable medium of claim 1, wherein the program further comprises a set of instructions for sending a confirmation to the consumer of the request to switch utility providers.

11. The non-transitory computer readable medium of claim 10, wherein the set of instructions for sending the confirmation to the consumer comprises a set of instructions for sending an SMS text message to the consumer.

12. The non-transitory computer readable medium of claim 10, wherein the set of instructions for sending the confirmation to the consumer comprises a set of instructions for sending an email message to the consumer.

13. The non-transitory computer readable medium of claim 1, wherein the program further comprises a set of instructions for displaying a utility contract renewal option for enabling the consumer to renew a present utility contract with a utility provider.

14. The non-transitory computer readable medium of claim 13, wherein the set of instructions for displaying the utility contract renewal option comprises sets of instructions for:
identifying an end date of the consumer's present utility contract;
determining whether the current date is within a threshold number of days of the identified end date; and
displaying an option to renew the contract when the current date is within the threshold number of days.

15. The non-transitory computer readable medium of claim 1, wherein the program further comprises a set of instructions for displaying a utility service bill-pay option which when selected allows the consumer to pay an existing utility service bill via the mobile computing device.
